(19) United States
(12) Patent Application Publication
(10) Pub. No.: US 2021/0042079 A1
(43) Pub. Date: Feb. 11, 2021

(54) DEVICE AND METHOD FOR MULTI-DISPLAY PROTOTYPING

(71) Applicant: DENSO TEN AMERICA LIMITED, Novi, MI (US)

(72) Inventor: Divya SESHADRI, Los Angeles, CA (US)

(73) Assignee: DENSO TEN AMERICA LIMITED, Novi, MI (US)

(21) Appl. No.: 16/535,153

(22) Filed: Aug. 8, 2019

(51) Int. Cl. G06F 3/14; G06F 3/0481; G06F 3/0484; G06F 8/34

(52) U.S. Cl. CPC G06F 3/1423; G06F 8/34; G06F 3/04847; G06F 3/04812

(57) ABSTRACT

A device for multi-display prototyping includes a processor that receives instructions for identifying in a memory a prototyping file that generates a plurality of windows on a single canvas. The processor may also receive instructions for total dimensions of the single canvas. And based on the received instructions, the processor may also span the single canvas over a plurality of display screens so that the plurality of windows are respectively displayed on the plurality of display screens.

### BACKGROUND

With advancements in display technology and increased user demands, automotive manufacturers are incorporating into vehicles multiple displays of various sizes, orientations, and locations. FIG. 1 shows an example of this, in which displays 10 and 20 are located in the vehicle dashboard for the driver's and/or co-passenger's use and displays 30 and 40 are located for passengers in the rear cabin. The ability to display, share, and transfer information between these displays is also gaining in popularity. Manufacturers are thus adding features and interactions that span across multiple screens of the displays in an attempt to engage users.

### SUMMARY

However, the information, orientation, grouping, associations, and interactions between the displays all vary, thereby often making it difficult for designers to make the displays work together seamlessly. These designers thus use rapid prototyping techniques (like paper prototyping) to test hypotheses about desirability and usability of their designs that span across multiple displays. Features of rapid prototyping include: fast development of the prototype, easy modification of the prototype, quicker iterations, flexibility, and the prototype generally being good enough for testing. These types of prototypes thus allow designers to develop efficiently robust User Interfaces through a fail-fast, fail-often approach that is validated with user testing.

For this purpose, developers and designers have attempted to use rapid prototyping tools such as INVISION, WEBFLOW, JUSTINMIND, POP, AXURE, MOCKPLUS, ORIGAMI, UXPIN, MARVEL, BALSAMIQ, and FRAMER to quickly validate and test their ideas. These tools convey various benefits—they are easy to learn, require little to no coding, allow a prototype to be developed quickly, and are easily distributed. But these tools are designed for web and mobile prototype developments, so they do not readily support multiple display prototyping environments such as that which would be useful for the implementation shown in FIG. 1. Other prototyping tools like EB GUIDE, QT, RIGHTWARE, CRANK, UNITY, and ALTIA, which arguably support such multi-display environments, require extensive software learning, coding, and development time such that they fail to realize the above-discussed purposes of rapid prototyping.

The present inventor has thus developed a solution that would help any automotive designer and/or developer to quickly prototype and test their multidisplay multimedia, or Human-Machine-Interface (“HMI”), solutions for a multi-display vehicle system in a realistic testing environment.

There may thus be provided, according to one or more aspects of the present disclosure, a device for multi-display prototyping that comprises a processor configured to: receive instructions for identifying in a memory a prototyping file that generates a plurality of windows on a single canvas; receive instructions for total dimensions of the single canvas; and based on the received instructions, span the single canvas over a plurality of display screens so that the plurality of windows are respectively displayed on the plurality of display screens.

Other aspects of the present disclosure may include a method for multi-display prototyping. This method may include: receiving instructions for identifying in a memory a prototyping file that generates a plurality of windows on a single canvas; receiving instructions for total dimensions of the single canvas; and based on the received instructions, spanning the single canvas over a plurality of display screens so that the plurality of windows are respectively displayed on the plurality of display screens.

And yet other aspects of the present disclosure may include a non-transitory computer-readable medium that, when executed by a processor of a computer, causes the computer to: receive instructions for identifying in a memory a prototyping file that generates a plurality of windows on a single canvas; receive instructions for total dimensions of the single canvas; and based on the received instructions, span the single canvas over a plurality of display screens so that the plurality of windows are respectively displayed on the plurality of display screens.

These and other non-limiting aspects of the present disclosure will be described with reference to the following detailed embodiments and accompanying drawings.

### BRIEF DESCRIPTION OF THE DRAWINGS

FIG. 1 shows an interior view of a vehicle that includes multiple displays.

FIG. 2 shows a prototyping system according to one or more aspects of the present disclosure.

FIG. 3 shows a configuration of a device for multi-display prototyping according to one or more aspects of the present disclosure.

FIG. 4 shows a flowchart outlining an exemplary process that may be performed by the device of FIG. 3.

FIG. 5 shows a display screen with a prototyping software tool loaded thereon.

FIG. 6 shows an exemplary graphical user interface in accordance with one or more aspects of the present disclosure.

FIG. 7 shows a single canvas spanned over multiple display screens in accordance with one or more aspects of the present disclosure.

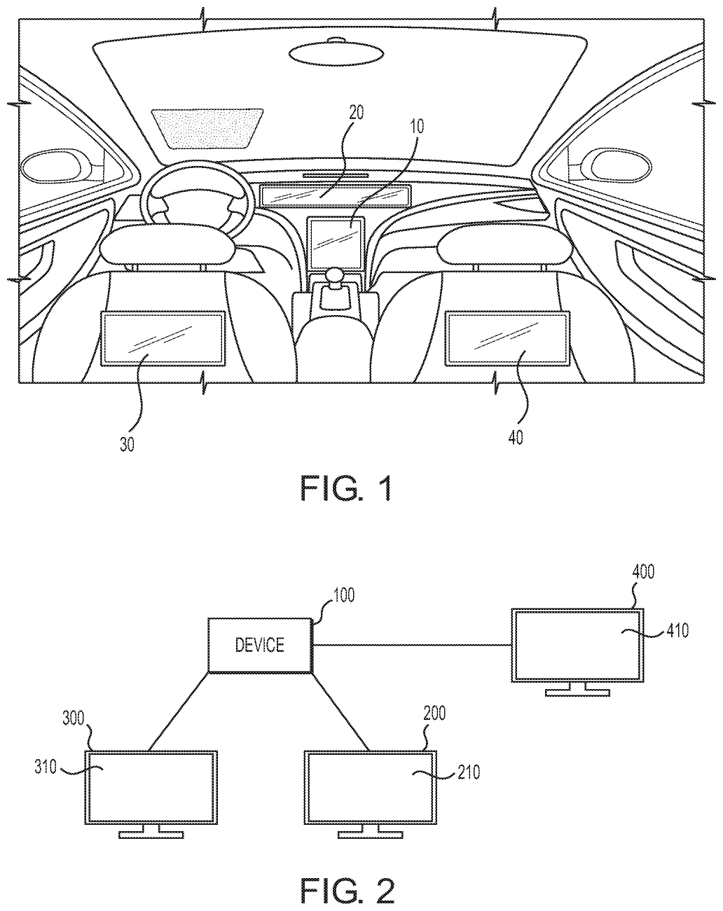

### DETAILED DESCRIPTION OF EMBODIMENTS

FIG. 2 shows a configuration of an exemplary system according to one or more aspects of the present disclosure. This system may include a prototyping device 100 communicatively connected to monitors or displays 200, 300, and 400. The displays 200, 300, and 400 may in turn respectively include display screens 210, 310, and 410. The prototyping device 100 may be any suitable computing device. It may be, for example, a personal computer (“PC”), or it may be a mobile telephone, smartphone, tablet, or other portable device able to be carried by a user. The prototyping device 100 may be connected to the displays 200, 300, and 400 by any suitable means, including direct connections such as VGA, DVI, or HDMI, and wide area or local area networks.

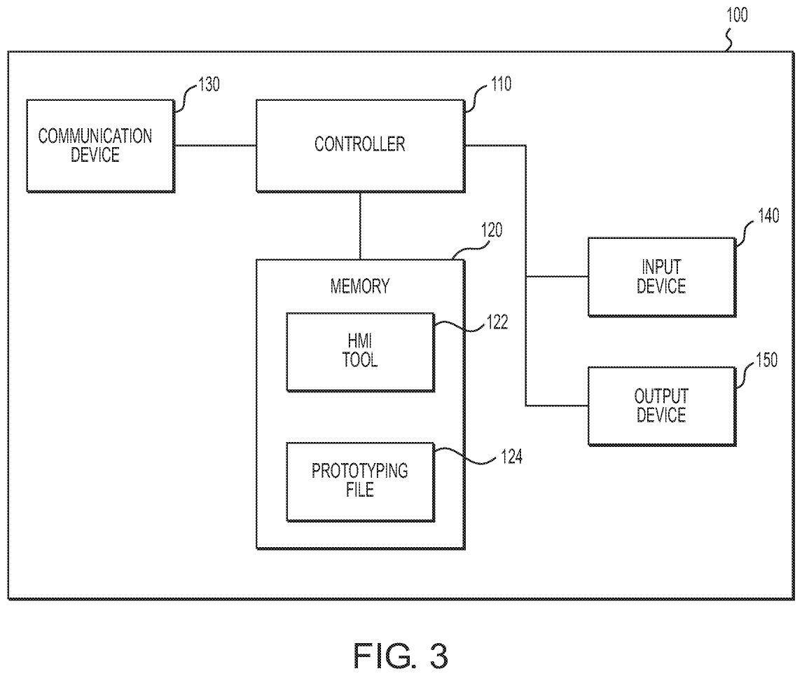

FIG. 3 shows an exemplary arrangement of the prototyping device 100. This device 100 may include a controller 110, a memory 120, a communication device 130, an input device 140, and an output device 150. The controller 110 may be a CPU, an MPU (optionally including a RAM and/or ROM), or any known or later-developed processor, circuit, or device for executing programs and instructions so as to operate the device 100. The memory 120 may in turn be implemented using any appropriate combination of alterable, volatile or non-volatile, memory or non-alterable, or fixed, memory. The alterable memory, whether volatile or non-volatile, may be implemented using any one or more of static or dynamic RAM, a floppy disk and disk drive, a writeable or rewriteable optical disk and disk drive, a hard drive, flash memory, or the like. Similarly, the non-alterable or fixed memory may be implemented using any one or more of ROM, PROM, EPROM, EEPROM, an optical ROM disk, such as CD-ROM or DVD-ROM disk and disk drive, or the like. The memory 120 may store various computer programs or instructions to be executed by, e.g., the controller 110. It may store, for example, a Human-Machine-Interface (“HMI”) Tool 122 described in detail later.

The communication device 130 may comprise the necessary wired or wireless hardware and/or software to enable communication with the device 100 by way of a local area or wide area network. It may be, for example, an RF transceiver through which electromagnetic signals are carried from one device to another. This communication device 130 may facilitate communication over the same bands as, e.g., mobile phones, or it may facilitate Wi-Fi communication to a local router, through which communication is made to the network. The input device 140 may be one or more of a keyboard, a mouse, a trackball, a touch screen, a virtual reality glove, or any known or later-developed device for inputting data and/or control signals to the device 100. And the output device 150 may be one or more of a display screen, speaker, or any known or later-developed device for outputting data from the device 100. Although not required, the output device 150 may be one or more of the monitors or displays 200, 300, and 400.

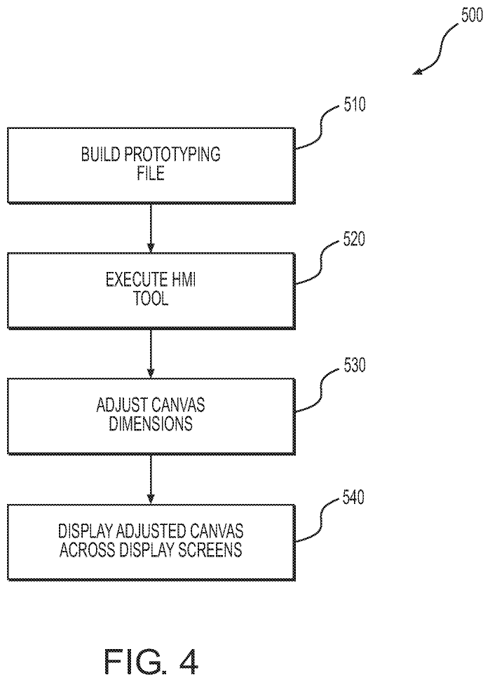

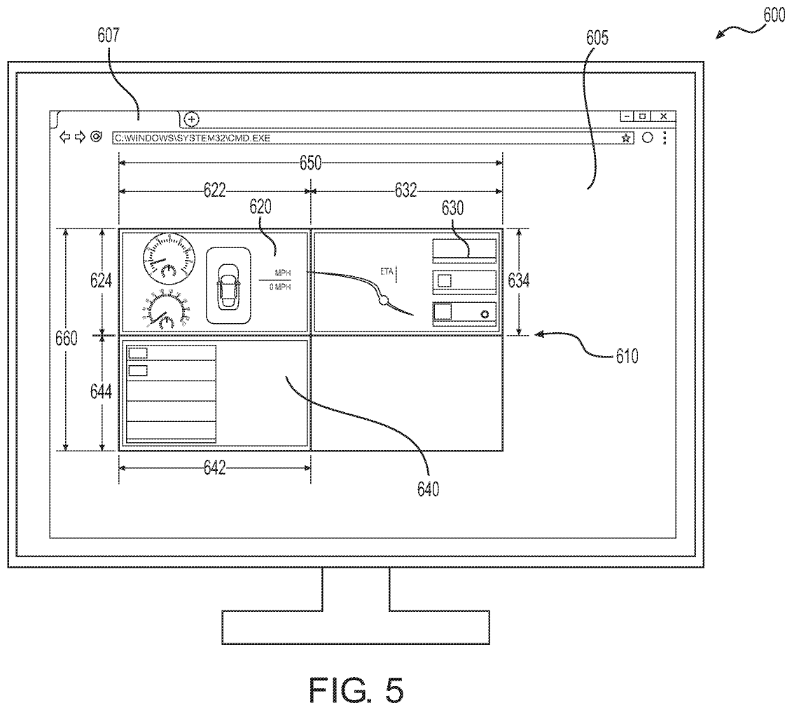

FIG. 4 shows a flowchart outlining steps 500 for multi-display prototyping. In the first Step 510, the prototyping file may be built. FIG. 5 shows a monitor or display 600, which may be an output device 150 of the prototyping device 100 or may be associated with any other suitable computing device. On a display screen of the display 600, a suitable prototyping software tool 605 may be displayed within a web browser 607. This prototyping software tool may be one of those previously mentioned that is designed for web and mobile prototype development, or it may be any other suitable tool. On a single canvas 610 of the software tool may be provided three separate windows 620, 630, and 640. As made clear below, the relative locations of these windows 620, 630, and 640 within the canvas 610 may correspond to the physical locations of the monitors or displays 200, 300, and 400. Although not so limited, the windows may be for use with an automobile. The window 620 may thus include current vehicle status information such as speed, engine coolant temperature, a tachometer, and fuel level; the window 630 may include navigation information such as estimated time to arrival (“ETA”) at a destination, and the window 640 may include information about recent destinations and the vehicle generally. Of course, the purpose of each window can be chosen depending on the designer's purpose and need. Although not required, these windows 620, 630, and 640 may interact with one another so that changes on one window may be reflected on one or more of the other windows. This may allow the windows to work in harmony so that interactions and information are seamlessly passed among the screens. Each of the windows may have a height and a width within the canvas 610, which may be defined in terms of pixels or any other suitable measure. More specifically, the window 620 may have a width 622 and a height 624; the window 630 may have a width 632 and a height 634; and the window 640 may have a width 642 and a height 644. The canvas 610 may thus have a total width 650 and a total height 660.

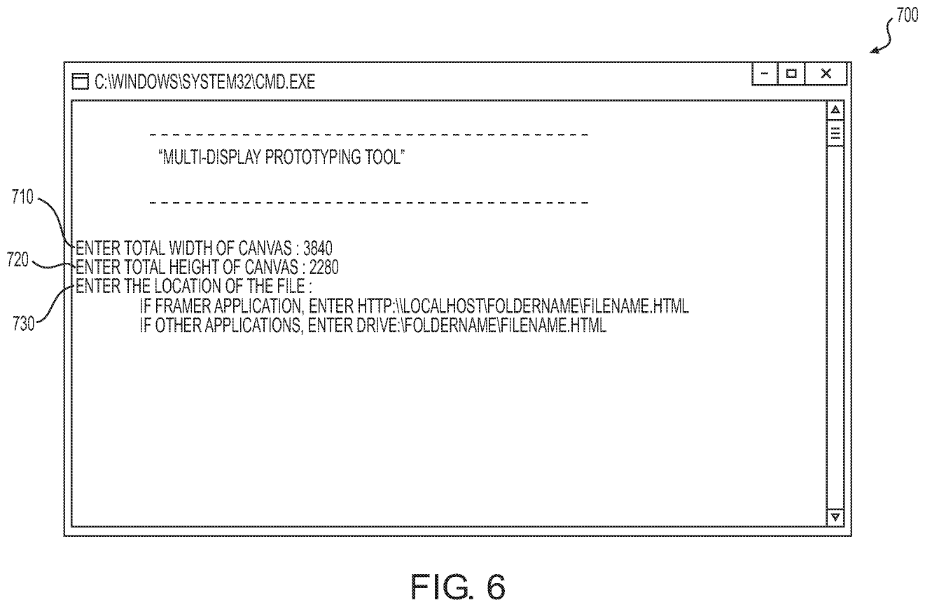

Once the prototyping file is built, the processor 110 of the prototyping device 100 may then execute at a Step 520 the HMI Tool 122 stored in the memory 120. Upon its execution, the HMI Tool 122 may cause to be displayed on the output device 150 of the device 100 the graphical user interface (“GUI”) 700 shown in FIG. 6. This GUI 700 may include various requests 710, 720, and 730. Request 730 may ask the user to input the location of the prototyping file built in Step 510. This file may be stored locally on the device 100 like the prototyping file 124 on the memory 120, or it may be stored remotely and accessible by way of the communication device 130 over a wide area or local area network. Request 710 may ask the user to specify the total width of the canvas 650, and Request 720 may ask the user to specify the total height of the canvas 660. The user may input suitable responses to the requests 710, 720, and 730 by way of the input device 140 of the prototyping device 100. In FIG. 6, for example, the user has input 3,840 pixels in reply to Request 710 and 2,280 pixels in reply to Request 720. As explained below, the user may obtain these suitable responses based on the sizes of the displays 200, 300, and 400.

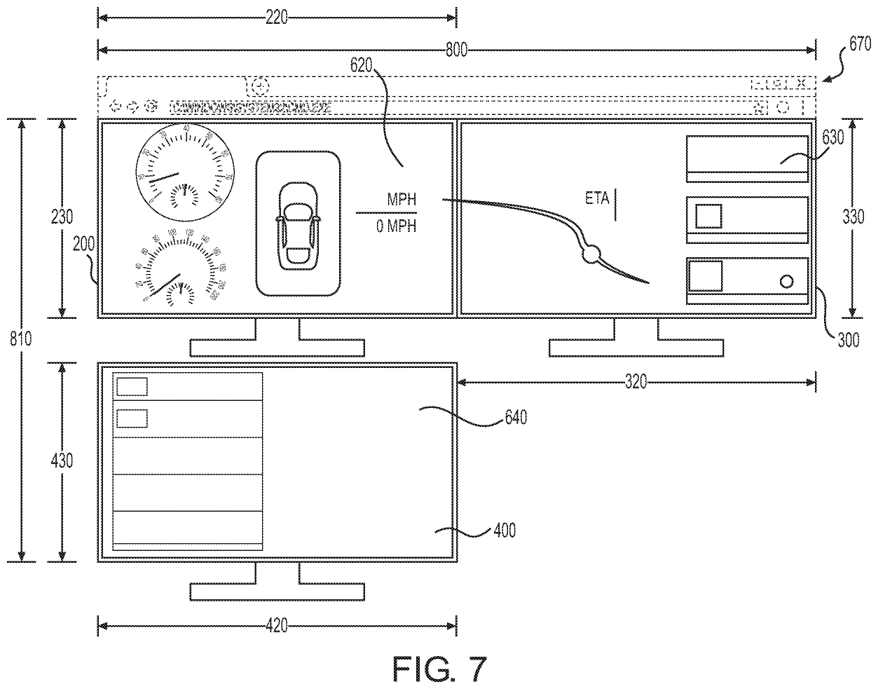

As explained previously, the browser 607 is the executable format of the canvas 610. The HMI Tool 122 may then adjust in a Step 530 the size of the browser 607 so that the total height and total width of the canvas 610 thereon correspond to the user's inputs in response to the Requests 710 and 720. And in a Step 540, the HMI Tool 122 may display the browser 607 containing the single canvas 610 so as to cause that canvas to be displayed across the monitors or displays 200, 300, and 400. The output of this Step 540 is shown in FIG. 7, and because the arrangement of the windows on the canvas 610 corresponds to that of the displays, the window 620 may be displayed on the display screen 210 of the display 200, the window 630 may be displayed on the display screen 310 of the display 300, and the window 640 may be displayed on the display screen 410 of the display 400. The HMI Tool 122 may accomplish this feat by adjusting the size of the browser based on the user's instructions so that the total width and total height of the canvas 610 correspond to the combined width 800 and combined height 810 of the display screens 210, 310, and 410. More specifically, the width 622 and height 624 of the window 620 may correspond to the width 220 and height 230 of the display screen 210 of the display 200; the width 632 and height 634 of the window 630 may correspond to the width 320 and height 330 of the display screen 310 of the display 300; and the width 642 and height 644 of the window 640 may correspond to the width 420 and height 430 of the display screen 410 of the display 400. Each window may thus occupy the entirety of the display screen on which it is displayed. And to further ensure that the windows occupy the entire display screens, the HMI Tool may further be arranged to position the browser window 607 so that any controls 670 of the web browser are contained in places not displayed on the display screens.

It is therefore possible by virtue of the above-described disclosure to quickly and cost-effectively generate a multi-display prototype. Although there may be only a single prototyping file and a single canvas, the operations of the HMI Tool allow each display screen to display a separate window. Relative to prior solutions, the devices and methods disclosed herein require no complex software programming, thus saving resources and development hours, and allowing designers and developers to quickly test their hypotheses and theories in real automotive test scenarios incorporating multiple displays. These devices and methods also allow interaction between different windows of the prototype, while allowing easy addition and removal of windows.

While the disclosure has been presented in conjunction with exemplary embodiments, these embodiments should be viewed as illustrative and thus not limiting of the present invention. Indeed, various modifications, substitutions, or the like are possible within the spirit and scope of the invention. For example, changes in the number and arrangement of windows can be performed by way of simple changes to the browser-based prototyping file. For example, instead of three windows as in the above examples, the canvas could be modified to have two windows, four windows, or any other number. This simplifies the iterative design process and allows ideas to be tested rapidly. And although the various Steps 510, 520, 530, and 540 of the process 500 are described as being performed by a controller 110, each of these steps may be performed by its own functional unit implemented by, e.g., a dedicated system such as an Application Specific Integrated Circuit (“ASIC”).

1. A device for multi-display prototyping, comprising a processor configured to:
receive instructions for identifying in a memory a prototyping file that generates a plurality of windows for a single canvas;
receive instructions for total dimensions of the single canvas; and
based on the received instructions, span the single canvas over a plurality of display screens so that the plurality of windows are respectively displayed on the plurality of display screens,
wherein total height and total width of the spanned single canvas correspond respectively to a combined height and a combined width of the plurality of display screens.

2. The device of claim 1, wherein the processor is configured to span the single canvas so that each of the windows is displayed on a single one of the display screens and each of the display screens displays only one of the windows.

3. The device of claim 2, wherein the processor is configured to span the single canvas so that each of the windows occupies the entire display screen on which it is displayed, hence eliminating a need for vertical and horizontal scrolling.

4. The device of claim 1, wherein the prototyping file generates the plurality of windows in an arrangement corresponding to that of the plurality of display screens.

5. The device of claim 1, wherein the plurality of windows generated by the prototyping file communicate and interact with each other.

6. The device of claim 1, wherein the processor is further configured to display on a display screen a graphical user interface prompting a user of the device to enter (i) at least one of a name and a location of the prototyping file in the memory and (ii) the total dimensions of the single canvas.

7. The device of claim 6, wherein:
the display screen on which the graphical user interface is displayed is one of the plurality of display screens; or
the display screen on which the graphical user interface is displayed is other than one of the plurality of display screens.

8. The device of claim 1, wherein the prototyping file is executable by a web browser.

9. The device of claim 8, wherein the processor is configured to span the single canvas over the plurality of display screens by adjusting the size of the web browser and positioning the web browser so that controls of the web browser are not displayed on the plurality of display screens.

10. A method for multi-display prototyping, comprising:
receiving instructions for identifying in a memory a prototyping file that generates a plurality of windows for a single canvas;
receiving instructions for total dimensions of the single canvas; and
based on the received instructions, spanning the single canvas over a plurality of display screens so that the plurality of windows are respectively displayed on the plurality of display screens,
wherein total height and total width of the spanned single canvas correspond respectively to a combined height and a combined width of the plurality of display screens.

11. The method of claim 10, wherein the single canvas is spanned so that each of the windows is displayed on a single one of the display screens and each of the display screens displays only one of the windows.

12. The method of claim 11, wherein the single canvas is spanned so that each of the windows occupies the entire display screen on which it is displayed, hence eliminating a need for vertical and horizontal scrolling.

13. The method of claim 10, wherein the prototyping file generates the plurality of windows in an arrangement corresponding to that of the plurality of display screens.

14. The method of claim 10, wherein the plurality of windows generated by the prototyping file communicate and interact with each other.

15. The method of claim 10, further comprising changing by a single user, at least one of the number and the location of the plurality of windows generated by the prototyping file.

16. The method of claim 10, further comprising, prior to the receiving of the instructions, displaying on a display screen a graphical user interface prompting a user to enter (i) at least one of a name and a location of the prototyping file in the memory and (ii) the total dimensions of the single canvas.

17. The method of claim 16, wherein:
the display screen on which the graphical user interface is displayed is one of the plurality of display screens; or
the display screen on which the graphical user interface is displayed is other than one of the plurality of display screens.

18. The method of claim 10, wherein the prototyping file is executable by a web browser.

19. The method of claim 18, wherein the single canvas is spanned over the plurality of display screens by adjusting the size of the web browser and positioning the web browser so that controls of the web browser are not displayed on the plurality of display screens.

20. A non-transitory computer-readable medium that, when executed by a processor of a computer, causes the computer to:
receive instructions for identifying in a memory a prototyping file that generates a plurality of windows for a single canvas;
receive instructions for total dimensions of the single canvas; and
based on the received instructions, span the single canvas over a plurality of display screens so that the plurality of windows are respectively displayed on the plurality of display screens,
wherein total height and total width of the spanned single canvas correspond respectively to a combined height and a combined width of the plurality of display screens.

21. The device of claim 1, wherein the single canvas is spanned so that, for each of the plurality of windows of the spanned canvas, a height and a width of the window respectively correspond to a height and a width of a corresponding one of the plurality of display screens on which the window is displayed.
